(19) United States
(12) Patent Application Publication
(10) Pub. No.: US 2006/0126358 A1
(43) Pub. Date: Jun. 15, 2006

(54) Backlight module

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/261,098

(22) Filed: Oct. 28, 2005

(30) Foreign Application Priority Data
Dec. 15, 2004 (CN) 200410077563.7

(51) Int. Cl. F21V 7/04

(52) U.S. Cl. 362/611

(57) ABSTRACT

A backlight module (100) used in a liquid crystal display device includes a light guide plate (101) and a field emission light source (110). The light guide plate includes a light incident surface (108), a light emitting surface (102) adjoining the light incident surface, and a bottom surface (105) opposite to the light emitting surface. The field emission light source faces the light incident surface. Compared with a light emitting diode or a cold cathode fluorescence lamp, the field emission light source 110 is capable of providing a brightness 10˜1000 times that of the light emitting diode or the cold cathode fluorescence lamp. Thus, the backlight module can achieve a high brightness and can save electric energy.

### BACKGROUND OF THE INVENTION

1. Field of the Invention

The present invention relates to a backlight module used in a liquid crystal display (LCD) device and, more particularly, to a backlight module incorporating a field emission device for a light source.

2. Discussion of the Related Art

In recent years, LCD devices, such as liquid crystal monitors, and liquid crystal TVs have become widely used. A typical LCD device includes an LCD panel and a backlight module mounted under the LCD panel for supplying light beams thereto. The backlight module mainly includes a light source and a light guide plate (LGP). The LGP is normally a transparent plate, and is used for guiding light beams emitted by the light source to uniformly illuminate the LCD panel.

FIG. 5 represents a conventional backlight module including a linear light source 5, a U-type reflector 6, an LGP 3, a reflective sheet 4, a diffusing sheet 2, and two light condensers 1. The linear light source 5 is placed at a side of the LGP 3. The linear light source 5 generally is an electroluminescent lamp (EL) or a cold cathode fluorescence lamp (CCFL). The U-type reflector 6 partly surrounds the linear light source 5. The reflective sheet 4, the LGP 3, the diffusing sheet 2, and the two light condensers 1 are arranged in that order.

In operation, the linear light source 5 emits light beams. One portion of the light beams is directly transmitted into the LGP 3, and the other portion of the light beams firstly is incident on the U-type reflector 6, then is reflected by the U-type reflector 6 and is transmitted into the LGP 3. The LGP 3 is used for guiding the light beams to exit from a light emitting surface 7 thereof. The reflective sheet 4 reflects the portion of light beams exiting from a bottom surface 8 of the LGP 3. That reflected portion of light beams are thus redirected to exit from the light emitting surface 7. The light beams exiting from the light emitting surface 7 sequentially pass through the diffusing sheet 2 and the light condensers 1. The light condensers 1 are configured for collimating diffused light beams emitting from the diffusing sheet 2.

The EL or the CCFL that is used as the linear light source 5 can generate a high brightness. However, the EL or the CCFL has an unduly large size and therefore occupies more valuable space of the backlight module. Therefore, the EL or the CCFL is generally implemented in a large sized LCD panel.

FIG. 6 illustrates a small sized backlight module 10 for illuminating a small sized LCD panel. In the case of the small sized backlight module 10, light sources 20 are two point light sources, e.g. two light emitting diodes (LEDs). The backlight module 10 further includes an LGP 22, and a reflective film or sheet 23 disposed under a bottom surface of the LGP 22. A plurality of V-shaped micro grooves is formed on a light emitting surface 221 of the LGP 22 for serving as a light condenser.

The LED light source 20 can save space with respect to the backlight module. However, the LED light source 20 cannot provide a uniform luminance. As shown in FIG. 7, there are some dark regions 261, 262 and 263 where the light beams emitting from LEDs 201 and 202 cannot reach. Therefore, if the planar surface 200 is used as the light emitting surface, dark regions may be displayed thereon. Such a backlight module 10 cannot provide a uniform brightness.

Besides the issues of space usage and uneven brightness, in order to properly illuminate a LCD panel, both large size and small sized backlight modules need to produce a sufficiently high brightness. However, the brightness of LED, EL and/or CCFL is limited due to theirs inherent properties. In addition, when the light propagates in the LGP, the reflective sheet, the diffusing sheet, and the light condenser, a significant portion of the light is absorbed and/or misdirected and thus not emitted via the light condenser. Thus, the amount of light originally generated by the light source that can actually be used to illuminate LCD panel is effectively decreased, and the brightness of the LCD panel is degraded.

What is needed, therefore, is a backlight module with a higher level of brightness.

### SUMMARY OF THE INVENTION

A backlight module according to one preferred embodiment includes a light guide plate and a field emission light source. The light guide plate includes a light incident surface, a light emitting surface adjoining the light incident surface, and a bottom surface opposite to the light emitting surface. The field emission light source faces the light incident surface.

Compared with a conventional backlight module employing a LED or CCFL light source, the field emission light source is capable of providing a brightness 10˜1000 times that of the LED or the CCFL. Thus, the backlight module of the present backlight module can achieve a high brightness and can save electric energy

Other advantages and novel features will become more apparent from the following detailed description of preferred embodiments when taken in conjunction with the accompanying drawings.

### BRIEF DESCRIPTION OF THE DRAWINGS

Many aspects of the backlight module can be better understood with reference to the following drawings. The components in the drawings are not necessarily to scale, the emphasis instead being placed upon clearly illustrating the principles of the present backlight module. Moreover, in the drawings, like reference numerals designate corresponding parts throughout the several views.

FIG. 1 is an isometric, schematic view of a backlight module, in accordance with a preferred embodiment;

FIG. 2 is a schematic, side view of a field emission light source of the backlight module of FIG. 1;

FIGS. 3A to 3E are schematic, cross-sectional views of an LGP of the backlight module of FIG. 1, taken along line III-III thereof, each showing a kind of diffusing dots on a bottom surface of the LGP;

FIG. 4 is a schematic, plan view of the LGP of the backlight module of FIG. 1, showing a distribution of the diffusing dots on the bottom surface of the LGP;

FIG. 5 is an isometric, schematic view of a first conventional backlight module;

FIG. 6 is an isometric, schematic view of a second conventional backlight module; and

FIG. 7 is schematic view showing dark areas formed on a planar surface using two LEDs, in accordance with the second conventional backlight module.

### DETAILED DESCRIPTION OF PREFERRED EMBODIMENTS

Reference will now be made to the drawings to describe preferred embodiments of the present backlight module in detail.

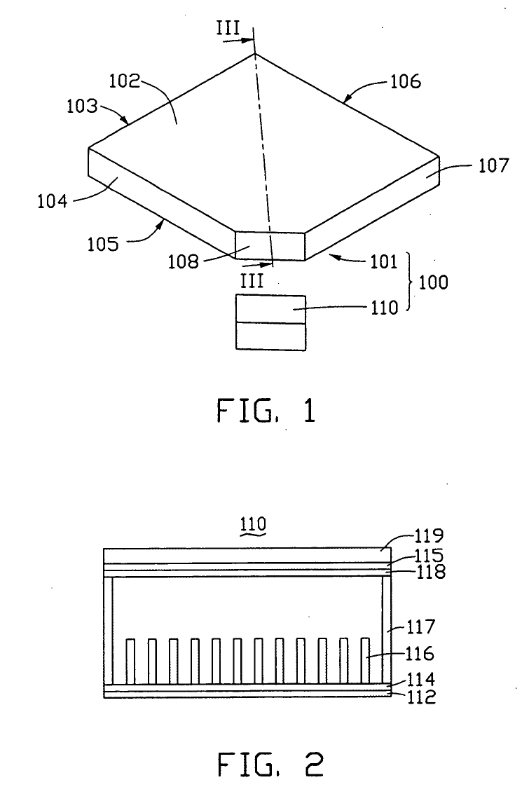

Referring to FIG. 1, a backlight module 100 in accordance with a preferred embodiment is shown. The backlight module 100 mainly includes an LGP 101 and a field emission light source 110.

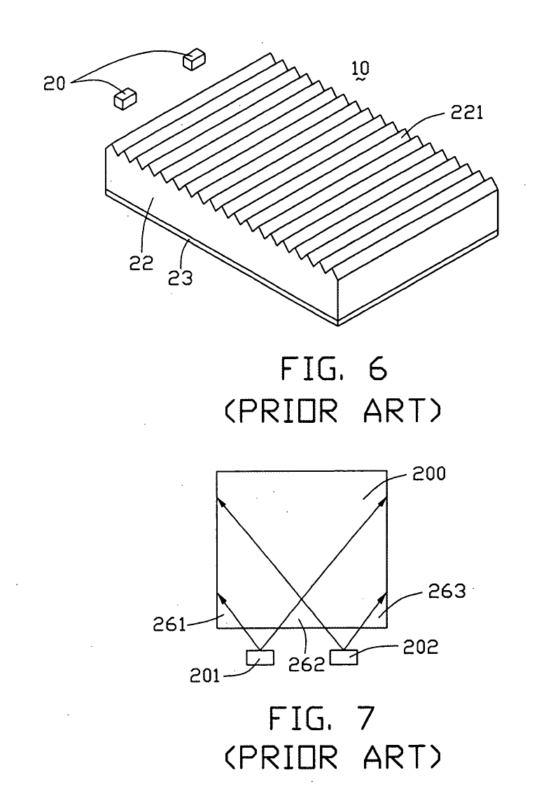

The LGP 101 is a light permeable member formed of a transparent material, such as acrylic resin, polycarbonate, polyethylene resin, and glass. The LGP 101 is a substantial cuboid (i.e., a rectangular parallelepiped) having a notched corner portion. A surface of the notched corner portion is utilized as a light incident surface 108 of the LGP 101. The LGP 101 further includes a light emitting surface 102 perpendicularly adjoining the light incident surface 108, a bottom surface 105 opposite to the light emitting surface 102, and four side surfaces 103, 104, 107, and 106. The surfaces 103, 104, 107, 106, and 105 can be configured to be reflective surfaces by coating reflective films (configured similar to the reflective film or sheet 23 schematically illustrated in FIG. 6) thereon, respectively. The light incident surface 108 is slanted/angled at a predetermined degree with respect to two side surfaces 104, 107. The predetermined degree is preferably about 45 degree. The field emission light source 110 is disposed at a side of the light incident surface 108 of the LGP 101 and is used for providing light beams for the LGP 101.

Referring to FIG. 2, the field emission light source 110 may be a field emission device using, for example, carbon nanotubes, as field emitters 116. The field emission light source 110, as illustrated, includes a conductive cathode layer 112, a catalyst layer 114 formed on the cathode layer 112, a plurality of field emitters 116 formed on the catalyst layer 114, and a transparent glass substrate 119 having a phosphor layer 118 formed on an inner surface thereof. The field emission light source 110 further incorporates an anode layer 115, generally sandwiched between the glass substrate 119 and the phosphor layer 118. Side walls 117 support the cathode layer 112 and the phosphor layer 118. A vacuum chamber (not labeled) is formed between the cathode layer 112, the phosphor layer 118, and the side walls 117.

The catalyst layer 114 has a nano-scale thickness, and the material of the catalyst layer 114 generally is selected from the group consisting of iron, nickel, and cobalt, and alloys of such metals. If the field emitters 116 are in the form of carbon nanotubes, as is advantageous, the field emitters 116 can be formed, e.g., by a chemical vapor deposition method, and the carbon nanotubes can be multi-walled nanotubes or single-walled nanotubes. A length of each carbon nanotube is in the range from about 0.1 to about 2 micrometers. A diameter of each carbon nanotube is in the range from about 5 to about 50 nanometers.

In operation, a voltage is applied between the cathode layer 112 and the anode layer 115, whereby an electric field is generated therebetween. Under the action of the electric field, electrons are extracted from the field emitters 116 and are accelerated to bombard the phosphor layer 118. Then, the phosphor layer 118 thereby emits light beams. The light beams pass through the glass substrate 119 and then are projected onto the light incident surface 108 of the LGP 101. The LGP 101 guides the light beams to exit from the light emitting surface 102 thereof. A brightness of the field emission light source 110 is advantageously very high. Compared with an LED or a CCFL, the field emission light source 110 is capable of providing a brightness 10˜1000 times that of the LED or the CCFL. Thus, the backlight module 100 can achieve a high brightness and can save electric energy.

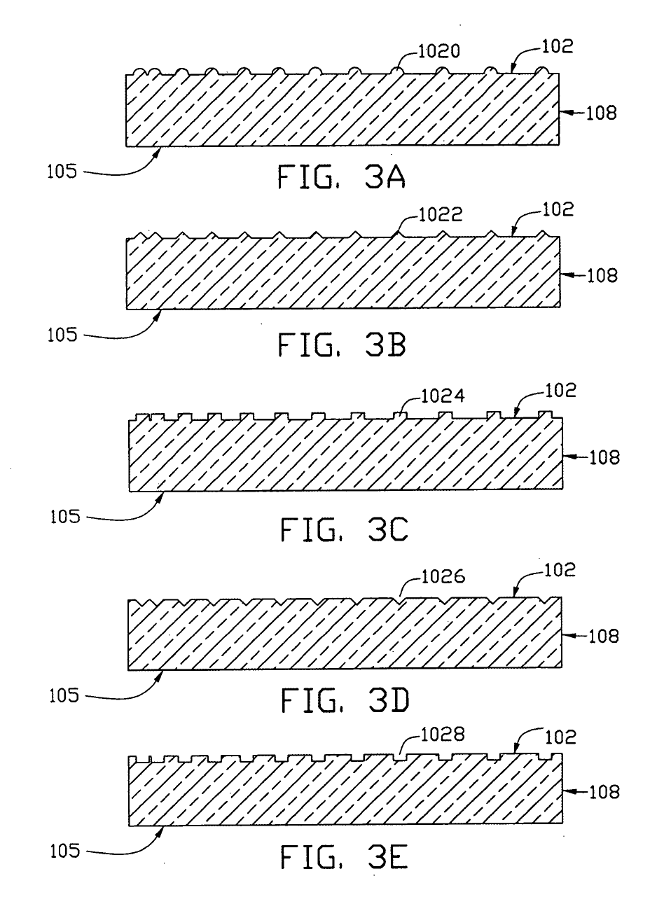

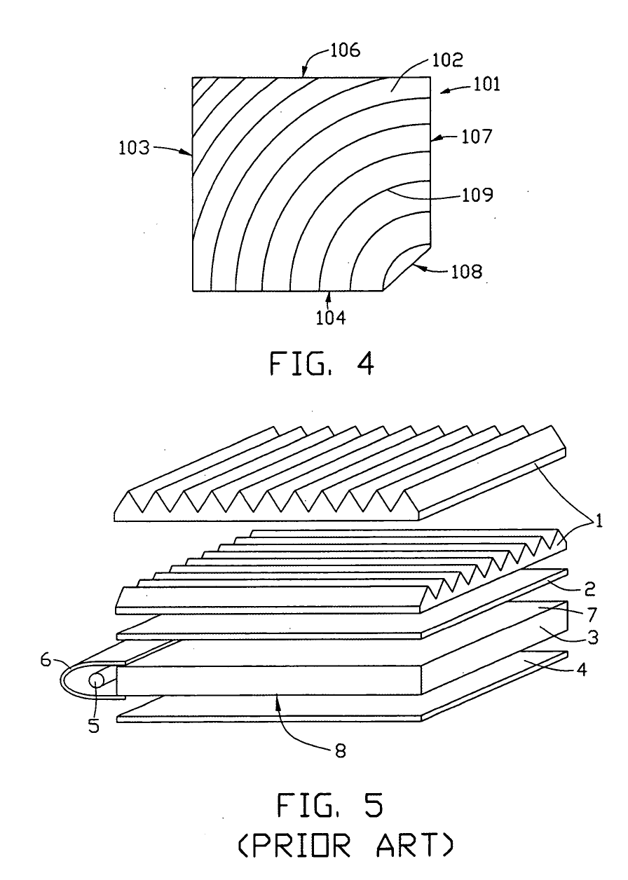

Referring to FIGS. 3A to 3E, in order to make the light beams evenly exit from the light emitting surface 102, a plurality of light diffusing dots, such as hemispherical projecting bumps 1020, V-shaped projecting bumps 1022 or square projecting bumps 1024, or V-shaped grooves 1026 or square grooves 1028 etc., can be formed thereon. Referring to FIG. 4, the light diffusing dots can be distributed along a plurality of concentric imaginary arc lines 109, such arc lines 109 thereby being intended to schematically represent the array of light diffusing dots. The imaginary arc lines 109 share a common center where the field emission light source 110 is disposed. A distribution density of the arc lines 109 progressively increases along a direction away from the field emission light source 110. Thus, a distribution density of the light diffusing dots progressively increases along the direction away from the field emission light source 110. Because the light intensity of the light beams in the LGP 101 decreases as the distance from the field emission light source 110 increases, a relatively higher distribution density of the light diffusing dots can diffuse more light beams. As such, the light beams are directed to uniformly exit from the light emitting surface 102.

The cathode layer 112 can advantageously be a metallic substrate configured for receiving an applied voltage therewithin and for thereby enhancing the strength of the field emission light source 110. A material of the metallic substrate can, advantageously, be copper or aluminum, or alloys composed substantially of one or both of such metals. The field emission light source 110 can further include a nonmetallic substrate (not shown) configured for supporting and electrically insulating the cathode layer 112. A material of the nonmetallic substrate can be silicon, glass, or a ceramic material. Additionally, a layer of copper, a copper alloy, or a copper-nickel alloy can be formed between the cathode layer 112 and the catalyst layer 114. A control circuit (not shown) can also be provided for controlling the field emission light source 110. The field emitters 116, instead of taking the form of carbon nanotubes, can be in the form of other nanomaterials or nanostructures. The other nanostructures can be nanofibers, nanowires, and/or nanorods. The other nanomaterial can be, for example, silicon nanotubes. It is to be further understood, however, that other known types and configurations of field emitters 116 (e.g., non-“nanostructure” emitters and/or emitters formed of other emissive materials) could yet be employed and still be within the scope of the present backlight module.

In addition, the backlight module 100 can further include a reflective sheet disposed under the bottom surface 105 of the LGP 101, a diffusing sheet disposed adjacent the light emitting surface 102, and at least a light condenser, disposed on the diffusing sheet. Such additional elements are illustrated, e.g., in FIG. 5.

It is to be understood that the above-described embodiments are intended to illustrate rather than limit the invention. Variations may be made to the embodiments without departing from the spirit of the invention as claimed. The above-described embodiments are intended to illustrate the scope of the invention and not restrict the scope of the invention.

What is claimed is:

1. A backlight module, comprising:
a light guide plate having a light incident surface, a light emitting surface adjoining the light incident surface, and a bottom surface opposite to the light emitting surface; and
a field emission light source facing the light incident surface.

2. The backlight module as claimed in claim 1, wherein the field emission light source comprises:
a transparent glass substrate having a first surface facing the light incident surface, and a second surface opposite to the first surface;
an anode layer formed on the second surface;
a phosphor layer formed on the anode layer;
a cathode layer opposite from the anode layer; and
a plurality of electron emitters formed on the cathode layer.

3. The backlight module as claimed in claim 2, wherein each electron emitter is a nanostructure.

4. The backlight module as claimed in claim 3, wherein each nanostructure is selected from the group consisting of a nanotube, a nanofiber, a nanowire, and a nanorod.

5. The backlight module as claimed in claim 3, wherein each electron emitter is comprised of a nanomaterial selected from one of carbon nanotubes and silicon nanotubes.

6. The backlight module as claimed in claim 5, wherein each electron emitter is a carbon nanotube, each carbon nanotube being one of a multi-walled nanotube and a single-walled nanotube.

7. The backlight module as claimed in claim 5, wherein each electron emitter is a carbon nanotube, each carbon nanotube having a length and a diameter, the length of each carbon nanotube being in the range from 0.1˜2 micrometers, the diameter of each carbon nanotube being in the range from 5˜50 nanometers.

8. The backlight module as claimed in claim 1, wherein the light guide plate has a cuboid shape having a notched corner portion, a surface of the notched corner portion serving as the light incident surface of the light guide plate.

9. The backlight module as claimed in claim 8, wherein a reflective film is formed on the bottom surface of the light guide plate.

10. The backlight module as claimed in claim 8, wherein the light emitting surface is perpendicular to the light incident surface.

11. The backlight module as claimed in claim 8, wherein a plurality of light diffusing dots is formed on the light emitting surface.

12. The backlight module as claimed in claim 11, wherein the light diffusing dot is selected from the group consisting of a hemispherical projecting bump, a V-shaped projecting bump, a square projecting bump, a V-shaped groove, and a square groove.

13. The backlight module as claimed in claim 11, wherein the light diffusing dots are distributed along a plurality of imaginary arc lines, the arc lines sharing a common center on which the field emission light source is disposed.

14. The backlight module as claimed in claim 11, wherein a distribution density of the light diffusing dots progressively increases along a direction away from the field emission light source.

15. The backlight module as claimed in claim 1, further comprising a reflective sheet disposed under the bottom surface of the light guide plate, a diffusing sheet adjacent the light emitting surface, and at least a light condenser disposed on the diffusing sheet.
